(19) United States
(12) Patent Application Publication
(10) Pub. No.: US 2019/0303400 A1
(43) Pub. Date: Oct. 3, 2019

(54) USING SELECTED GROUPS OF USERS FOR AUDIO FINGERPRINTING

(71) Applicant: Axwave, Inc., Menlo Park, CA (US)

(72) Inventors: Damian Scavo, Menlo Park, CA (US); Loris D'Acunto, Palo Alto, CA (US); Fernando Flores, New York, NY (US)

(21) Appl. No.: 16/147,186

(22) Filed: Sep. 28, 2018

Related U.S. Application Data
(60) Provisional application No. 62/566,198, filed on Sep. 29, 2017.
(60) Provisional application No. 62/566,142, filed on Sep. 29, 2017.

(51) Int. Cl. G06F 16/683; G06K 9/00; G06F 16/68

(52) U.S. Cl. CPC G06F 16/683; G06F 16/686; G06K 9/0055

(57) ABSTRACT

A computer-implemented method includes receiving a recorded audio signal recorded through an interface associated with the mobile application, adding metadata through the mobile application, confirming the metadata, receiving audio recorded from a nearby source, processing the recording based on significant features, generating digital audio fingerprints, submitting the fingerprints to a server, and detecting a type of content or media associated with the received fingerprint to provide a rich result dataset with different tagged content and metadata structures.

This application claims priority under 35 U.S.C. 119(a) to U.S. Provisional Application No. 62/566,198 and U.S. Provisional Application No. 62/566,142, both filed on Sep. 29, 2017, the content of which is incorporated herein in its entirety for all purposes.

### BACKGROUND

### Technical Field

An objective of the example implementations is to provide a way to uniquely identify original audio signals (i.e., digital audio fingerprints) and storing those fingerprints in a database to compare those fingerprints to other pieces of audio data.

### 2. Related Art

### SUMMARY

An objective of the example implementations is to provide a distributed client-server platform in which groups of users contribute to the generation of audio fingerprints for different types of original media content such as feature-length movies, music, television series, or documentaries from OTT providers and streaming services such as Netflix, Amazon Video, or Hulu.

A computer-implemented method is provided herein. A recorded audio signal is received through an interface associated with an online mobile application. This online mobile application is configured to add metadata to the recorded audio signal and provides the recorded audio signal with the metadata. The provided metadata is then confirmed, and recorded audio is received from a media source. The recorded audio is then processed by identifying features on the recorded audio signal, data is extracted based on those features, and one or more patterns are identified in the recording based on iterative self-learning. Digital audio fingerprints are then generated based on the recorded audio, and those fingerprints and associated metadata are then sent to a server.

### BRIEF DESCRIPTION OF THE DRAWINGS

FIG. 1 illustrates the general infrastructure, according to an example implementation.

FIG. 2 illustrates a client-side flow diagram, according to an example implementation.

FIG. 3 illustrates a server-side flow diagram, according to an example implementation.

FIG. 4 illustrates the merging of audio content, according to an example implementation.

FIG. 5 illustrates an example process, according to an example implementation.

FIG. 6 illustrates an example environment, according to an example implementation.

FIG. 7 illustrates an example processor, according to an example implementation.

### DETAILED DESCRIPTION

The following detailed description provides further details of the figures and example implementations of the present specification. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

Key aspects of the present application include recording audio data, extracting significant features on that audio data, and generating fingerprints associated with the audio data.

For example, but not by way of limitation, according to the present example of patience, one or more users are selected to form a panel of users, each of which has an online location. Online mobile application is configured to receive audio information, and perform an enhancement operation on the received audio information, such as by a self learning process. Based on the enhancement, the fingerprints are generated and submitted to a server. The server queues up the fingerprints, determines if they are already in the database, and if so performs a quality check and update the database if the submission is not already in the database, the quality check process may be skipped as there is no checking to be done based on the content not being database, and the database is then updated to include the content. The example implementations are also directed to checking new content from a user with content stored in database or matching of cult points, and merging of signals that are then entered the database at the server. As a result, the quality of digital fingerprints may be optimized.

### 1. User Selection

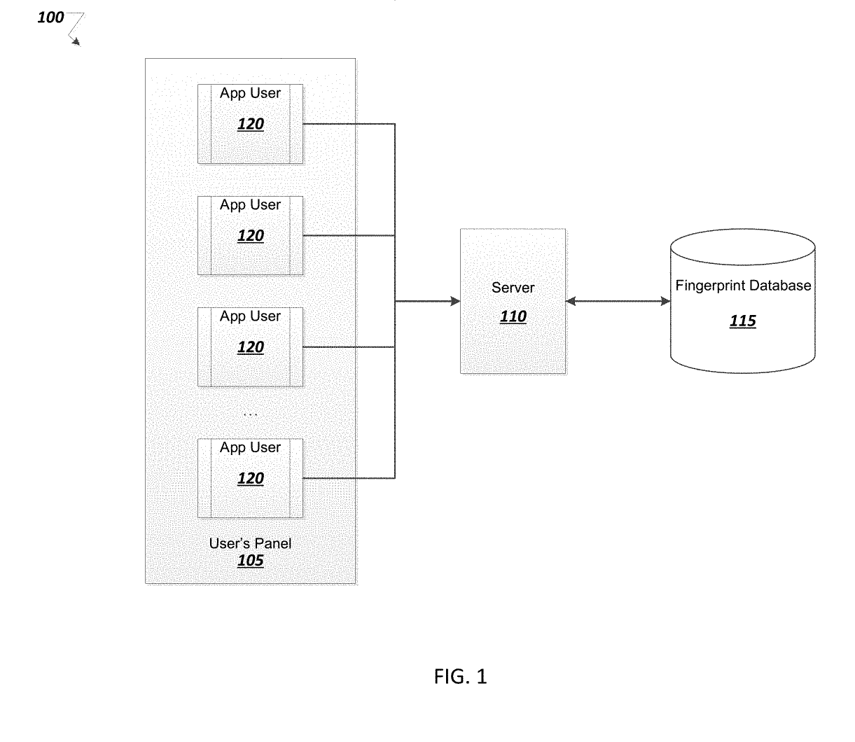

In environment 100, shown in FIG. 1, users can select and run processes, forming a panel 105. A panel is a group of users with certain qualifications or associations. For example, a panel can be selected for a specific purpose and for a time (e.g., predetermined) that can be disbanded thereafter. Therefore, panelists can be treated as individuals to complete the audio recording process by using an online mobile application provided for that purpose.

### 2. Client Side: Mobile Application

An online mobile application is designed and implemented to have features needed to record streams of sound through its input interface (e.g., microphone), where the result can be tagged with metadata and sent to a server 110 and then stored in an audio database 115.

For example, panel members 120 activate a client application that includes modules (e.g., functions) to:

i. Metadata Selection
In environment 100, a screen is provided indicating a type of tagged content 205 or media (e.g., television series, movie, advertisement, television show, etc.) and additional metadata can be configured at the app user panel 105. Each content type can have an associated metadata structure. For example, a television series episode will include information about the episode title, plot, and season and series number, and a television advertisement will include the brand name.

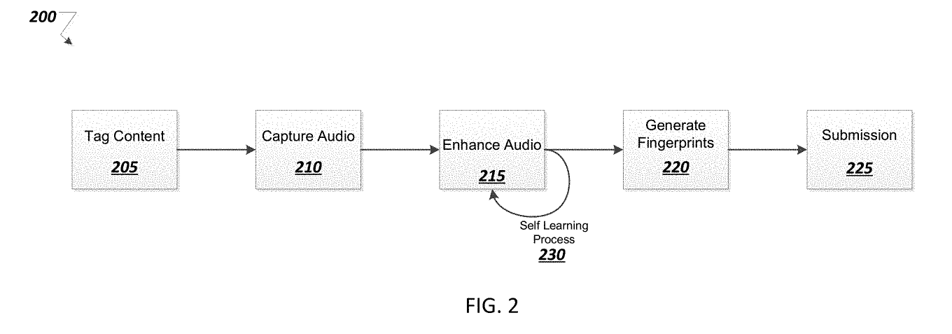

ii. Audio Recording
In environment 200, shown in FIG. 2, once the metadata has been confirmed, the device running the application has to be placed nearby the media source (i.e., TV set, computer, etc.), and the audio from such source will start to be recorded at 210. Through its audio input interface, the device where the application is running records a stream of sound that is processed locally, via a machine learning algorithm 215, that extracts and processes the most significant features on the audio signal recorded (set of frequencies, amplitudes, and phases of the signal) in order to obtain a cleaner and clearer result signal. The information used in this operation is used to identify patterns that will optimize the process on the next iterative executions. These iterative executions are the base of the self-learning process 230. This operation may be executed in parallel by different clients running the mobile application.

iii. Fingerprint Generation at 220
Each client application has the ability to generate digital audio fingerprints (i.e., condensed digital summaries, deterministically generated from an audio signal that can be used to identify an audio sample or quickly locate similar items in an audio database). The fingerprint generation process is run either second-by-second (e.g., real time) or in batches (i.e., 30 minutes of audio content), depending on the configuration chosen for the device used.
Fingerprints can be generated by applying a cryptographic hash function to an input (in this case, audio signals). They may be one-way functions, that is, functions which are infeasible to invert. Moreover, only a fraction of the audio is used to create the fingerprints. The combination of these two methodologies enables the possibility of storing digital fingerprints without infringing copyright laws.

iv. Submission to the Server at 225
Once the recording has finished, either because of a timeout or because of a user action, the application sends the fingerprints and metadata associated to the fingerprints to the server through a secure TCP/UDP connection, and the application returns to the initial state, ready to start a new session.

### 3. Server

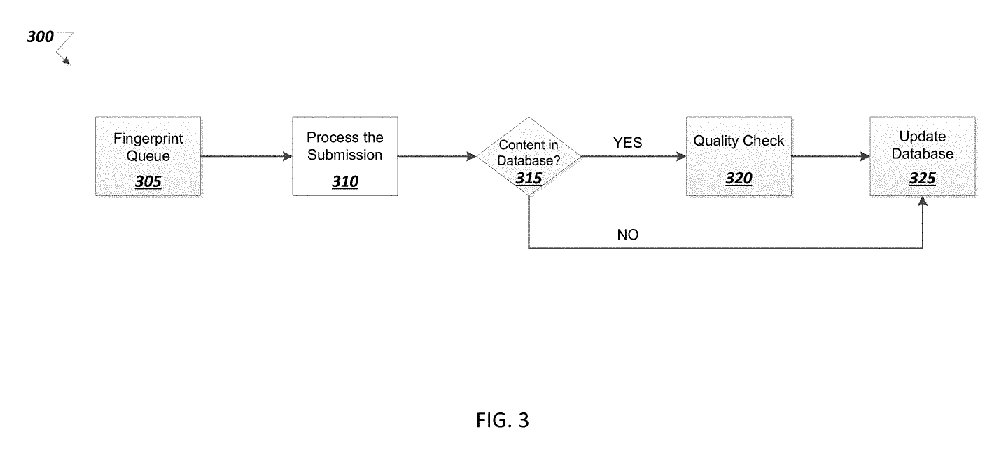

In environment 300, shown in FIG. 3, a central point (server or group of servers) receives the application's submissions and adds the submissions to a fingerprint queue 305. When a given submission has reached its turn, that submission is processed at 310 and the submission then goes through a new algorithm that will try to merge that submission to other fingerprint chunks of the same piece of content, as defined by the metadata associated.

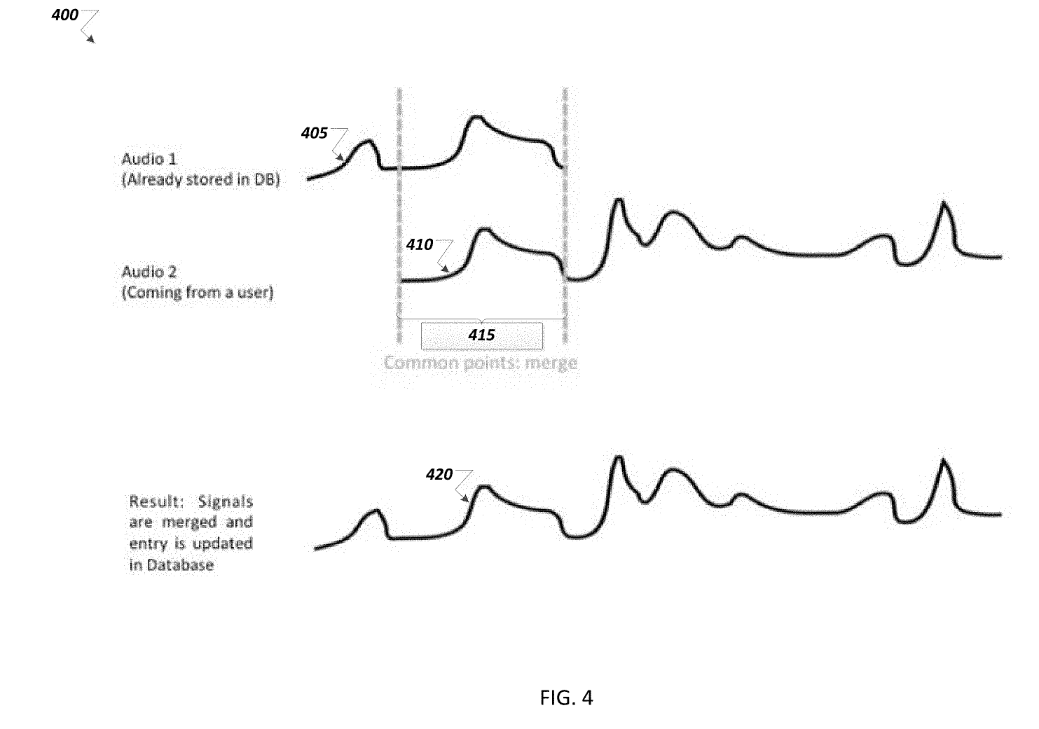

Firstly, at 315, the database will be queried to obtain existing pieces of the same content. If existing pieces of the same content are obtained, the algorithm will look for common points between the existing pieces and the new content from the user where the pieces of content will be merged at 320 and FIG. 4. Otherwise, a new entry is created in the fingerprint database 115 for this content at 325.

Since every recording goes through the same process on the client side, pieces of content should fit smoothly with those pieces of content already stored on the fingerprint database 115. However, there may be occasions where some inconsistencies happen (i.e., due to background noise in the audio capture process). In these cases, the server will apply an algorithm to normalize the problematic pieces at 230, attempting to make them fit with the existing entries. The algorithm learns from previous cases and becomes more accurate through each iteration.

When different users send fingerprints corresponding to the very same content, they will be compared to each other to determine if the fingerprints are consistent (i.e., the same content generates the same fingerprints in different devices). If this is not the case, an algorithm will determine the quality and consistency of each set of fingerprints, deciding which set of fingerprints to keep in the database. If more than one set of fingerprints are considered to fit, all of them will be saved in the database.

In order to take advantage of the self-learning process performed by this algorithm, each fingerprint set is saved and linked to the user and the device that generated it, so that certain patterns are identified and applied in earlier processing phases for future contributions. Thus, fingerprint sets will be normalized and will contribute to the enhancement of the database in a more accurate and resource-effective way. Once the matching process has finished, the new entry is updated in the database at 325.

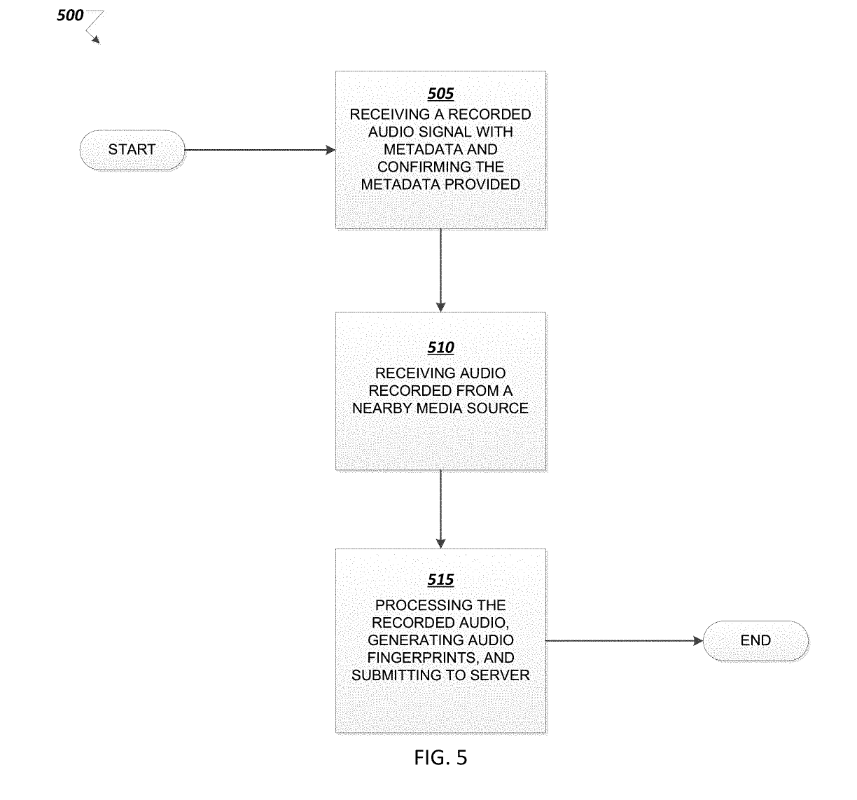

FIG. 5 shows an example process suitable for some example implementations. Within environment 500, a recorded audio signal is received with metadata and then that metadata is confirmed at 505. At 510, recorded audio is then received from a nearby media source. At 515, the recorded audio is processed, fingerprints associated with the recorded audio are generated, and then the fingerprints are sent to a server.

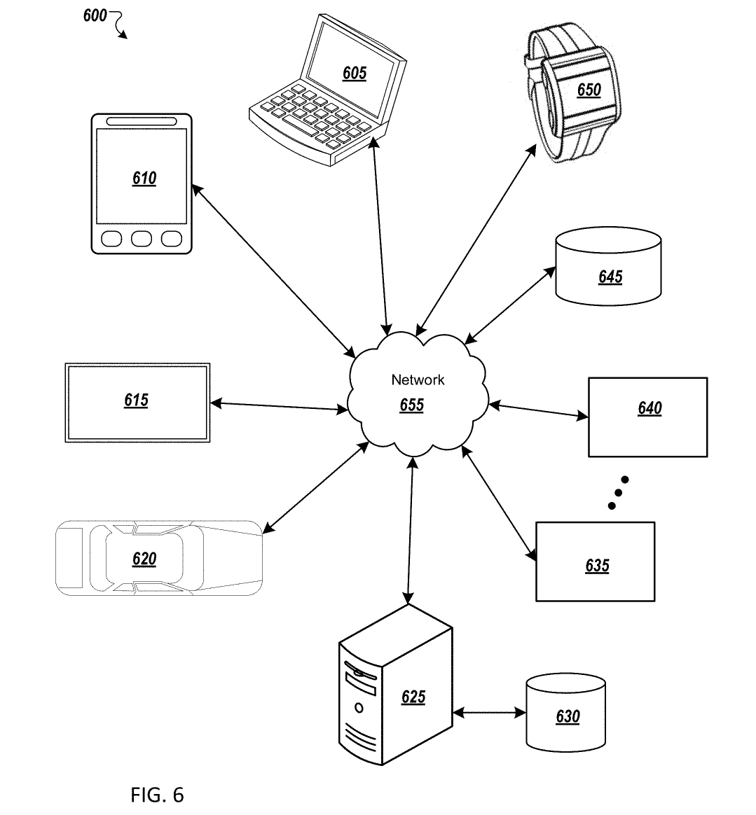

FIG. 6 shows an example environment suitable for some example implementations. Environment 600 includes devices 605-650, and each is communicatively connected to at least one other device via, for example, network 655 (e.g., by wired and/or wireless connections). Some devices may be communicatively connected to one or more storage devices 630 and 645. Devices 605-650 may include, but are not limited to, a computer 605 (e.g., a laptop computing device), a mobile device 610 (e.g., a smartphone or tablet), a television 615, a device associated with a vehicle 620, a server computer 625, computing devices 635-640, wearable technologies with processing power (e.g., smart watch) 650, and storage devices 630 and 645.

Example implementations may also relate to an apparatus for performing the operations herein. The apparatus may be specially constructed for the required purposes, or the apparatus may include one or more general-purpose computers selectively activated or reconfigured by one or more computer programs. Such computer programs may be stored in a computer-readable medium, such as a computer-readable storage medium or a computer-readable signal medium.

A computer-readable storage medium may involve tangible mediums such as, but not limited to optical disks, magnetic disks, read-only memories, random access memories, solid state devices and drives, or any other types of tangible or non-tangible media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

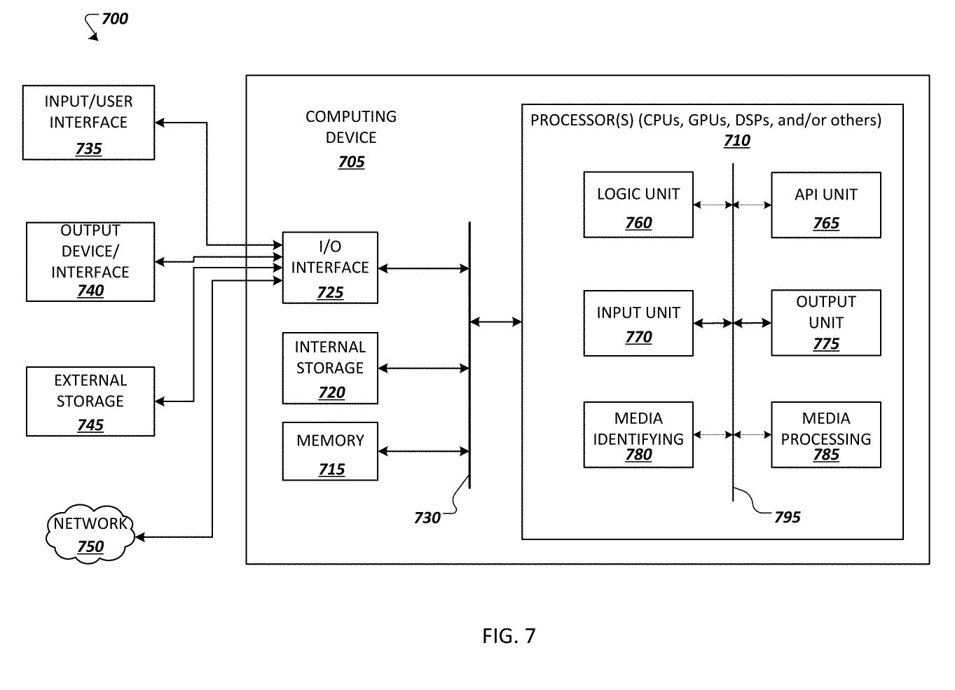

FIG. 7 shows an example computing environment with an example computing device suitable for implementing at least one example embodiment. Computing device 705 in computing environment 700 can include one or more processing units, cores, or processors 710, memory 715 (e.g., RAM, ROM, and/or the like), internal storage 720 (e.g., magnetic, optical, solid state storage, and/or organic), and I/O interface 725, all of which can be coupled on a communication mechanism or bus 730 for communicating information. Processors 710 can be general purpose processors (CPUs) and/or special purpose processors (e.g., digital signal processors (DSPs), graphics processing units (GPUs), and others).

In some example embodiments, computing environment 700 may include one or more devices used as analog-to-analog converters, digital-to-analog converters, and/or radio frequency handlers.

Computing device 705 can be communicatively coupled to external storage 745 and network 750 for communicating with any number of networked components, devices, and systems, including one or more computing devices of the same or different configuration. Computing device 705 or any connected computing device can be functioning as, providing services of, or referred to as a server, client, thin server, general machine, special-purpose machine, or another label.

I/O interface 725 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computing device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage) and other non-volatile storage or memory.

Computing device 705 can be used to implement techniques, methods, applications, processes, or computer-executable instructions to implement at least one embodiment (e.g., a described embodiment). Computer-executable instructions can be retrieved from transitory media and stored on and retrieved from non-transitory media. The executable instructions can be originated from one or more of any programming, scripting, and machine languages (e.g., C, C++, Java, Visual Basic, Python, Perl, JavaScript, and others).

Processor(s) 710 can execute under any operating system (OS) (not shown), in a native or virtual environment. To implement a described embodiment, one or more applications can be deployed that include logic unit 760, application programming interface (API) unit 765, input unit 770, output unit 775, media identifying unit 780, and inter-communication mechanism 795 for the different units to communicate with each other, with the OS, and with other applications (not shown). For example, media identifying unit 780 and media processing unit 785 may implement one or more processes described above. The described units and elements can be varied in design, function, configuration, or implementation and are not limited to the descriptions provided.

In some examples, logic unit 760 may be configured to control the information flow among the units and direct the services provided by API unit 765, input unit 770, output unit 775, media identifying unit 780, and media processing unit 785 to implement an embodiment described above. For example, the flow of one or more processes or implementations may be controlled by logic unit 760 alone or in conjunction with API unit 765.

Various general-purpose systems may be used with programs and modules in accordance with the examples herein, or it may prove convenient to construct a more specialized apparatus to perform desired method operations. In addition, the example implementations are not described with reference to any particular programming language. It will be appreciated that a variety of programming languages may be used to implement the teachings of the example implementations as described herein. The instructions of the programming language(s) may be executed by one or more processing devices [e.g., central processing units (CPUs), processors, or controllers].

As is known in the art, the operations described above can be performed by hardware, software, or some combination of hardware and software. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application.

Further, some example implementations of the present application may be performed solely in hardware, whereas other example implementations may be performed solely in software. Moreover, the various functions described can be performed in a single unit, or the functions can be spread out across a number of components in any number of ways. When performed by software, the methods may be executed by a processor, such as a general purpose computer, based on instructions stored on a computer-readable medium. If desired, the instructions can be stored on the medium in a compressed and/or encrypted format.

The example implementations may have various differences and advantages over related art. For example, but not by way of limitation, as opposed to instrumenting web pages with JavaScript as known in the related art, text and mouse (i.e., pointing) actions may be detected and analyzed in video documents. Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

1. A computer-implemented method for identifying and storing digital audio fingerprints, the method comprising:
receiving a recorded audio signal recorded through an interface associated with an online mobile application, where the mobile application is configured to add metadata to the recorded audio signal and provides the recorded audio signal with the metadata;
confirming the metadata provided;
receiving audio recorded from a media source;
processing the recorded audio by identifying features on the recorded audio signal, extracting data based on the features, and identifying one or more patterns in the recording based on iterative self-learning;
generating the digital audio fingerprints based on the recorded audio; and
submitting the digital audio fingerprints and associated metadata to a server.

2. The method of claim 1, further comprising, the server performing the following:
generating a queue of fingerprints based on the submitting of the fingerprints to the server;
merging the fingerprints into common pieces of content based on the metadata;
searching a database of stored pieces of the common content;
identifying common points where the common pieces and the stored pieces of content can be merged; and
creating and storing a new entry in the database for the content for the common pieces and the stored pieces that cannot be merged.

3. The method of claim 2, further comprising:
determining whether the common pieces and the stored pieces of content that cannot be merged match at one or more points; and
analyzing the matched points for adjacent positions with common characteristics;
wherein the common characteristics are located based on a threshold lower than a matching threshold.

4. The method of claim 1, wherein the received recorded audio is normalized before being processed.

5. The method of claim 1, wherein the generated digital audio fingerprints are linked to the interface associated with the online mobile application,
wherein patterns are identified and applied in the processing the generated audio fingerprints for a later recorded audio signal.

6. A system comprising:
a memory;
a processor operatively coupled to the memory, the processor configured to:
receive a recorded audio signal recorded through an interface associated with an online mobile application, where the mobile application is configured to add metadata to the recorded audio signal and provides the recorded audio signal with the metadata;
confirm the metadata provided;
receive audio recorded from a media source;
process the recorded audio by identifying features on the recorded audio signal, extracting data based on the features, and identifying one or more patterns in the recording based on iterative self-learning;
generate the digital audio fingerprints based on the recorded audio; and
submit the digital audio fingerprints and associated metadata to a server.

7. The system of claim 6, further comprising, the server performing the following:
generating a queue of fingerprints based on the submitting of the fingerprints to the server;
merging the fingerprints into common pieces of content based on the metadata;
searching a database of stored pieces of the common content;
identifying common points where the common pieces and the stored pieces of content can be merged; and
creating and storing a new entry in the database for the content for the common pieces and the stored pieces that cannot be merged.

8. The system of claim 7, further comprising:
determining whether the common pieces and the stored pieces of content that cannot be merged match at one or more points; and
analyzing the matched points for adjacent positions with common characteristics;
wherein the common characteristics are located based on a threshold lower than a matching threshold.

9. The system of claim 6, wherein the received recorded audio is normalized before being processed.

10. The system of claim 6, wherein the generated digital audio fingerprints are linked to the interface associated with the online mobile application,
wherein patterns are identified and applied in the processing the generated audio fingerprints for a later recorded audio signal.

11. A non-transitory computer readable medium, comprising instructions that when executed by a processor, the instructions to:
receive a recorded audio signal recorded through an interface associated with an online mobile application, where the mobile application is configured to add metadata to the recorded audio signal and provides the recorded audio signal with the metadata;
confirm the metadata provided;
receive audio recorded from a media source;
process the recorded audio by identifying features on the recorded audio signal, extracting data based on the features, and identifying one or more patterns in the recording based on iterative self-learning;
generate the digital audio fingerprints based on the recorded audio; and
submit the digital audio fingerprints and associated metadata to a server.

12. The non-transitory computer readable medium of claim 11, further comprising, the server performing the following:
generating a queue of fingerprints based on the submitting of the fingerprints to the server;
merging the fingerprints into common pieces of content based on the metadata;
searching a database of stored pieces of the common content;
identifying common points where the common pieces and the stored pieces of content can be merged; and
creating and storing a new entry in the database for the content for the common pieces and the stored pieces that cannot be merged.

13. The non-transitory computer readable medium of claim 12, further comprising:
determining whether the common pieces and the stored pieces of content that cannot be merged match at one or more points; and
analyzing the matched points for adjacent positions with common characteristics;
wherein the common characteristics are located based on a threshold lower than a matching threshold.

14. The non-transitory computer readable medium of claim 11, wherein the received recorded audio is normalized before being processed.

15. The non-transitory computer readable medium of claim 11, wherein the generated digital audio fingerprints are linked to the interface associated with the online mobile application,
wherein patterns are identified and applied in the processing the generated audio fingerprints for a later recorded audio signal.
